(19) United States
(12) Patent Application Publication
(10) Pub. No.: US 2020/0378029 A1
(43) Pub. Date: Dec. 3, 2020

(54) DEVICE AND METHOD FOR ANODIZED OXIDATION OF AN ANODE ELEMENT FOR A CURVED X-RAY GRATING, SYSTEM FOR PRODUCING A CURVED X-RAY GRATING AND CURVED X-RAY GRATING

(71) Applicants: KONINKLIJKE PHILIPS N.V., EINDHOVEN (NL); NEDERLANDSE ORGANISATIE VOOR TOEGEPAST NATUURWETENSCHAPPELIJK ONDERZOEK TNO, Den Haag (NL)

(72) Inventors: GEREON VOGTMEIER, AACHEN (DE); CHRISTIAAN KOK, NOORD-BRABANT (DE); THOMAS KOEHLER, NORDERSTEDT (DE); ANDRIY YAROSHENKO, GARCHING (DE); JOHANNES WILHELMUS MARIA JACOBS, BOXTEL (NL); SANDEEP NIKRISHNAN, VELDHOVEN (NL); DOROTHEE HERMES, EINDHOVEN (NL); ANTONIUS MARIA BERNARDUS VAN MOL, EINDHOVEN (NL)

(21) Appl. No.: 16/771,268

(22) PCT Filed: Dec. 10, 2018
(86) PCT No.: PCT/EP2018/084072

§ 371 Date: Jun. 10, 2020

(30) Foreign Application Priority Data
Dec. 12, 2017 (EP) 17206677.1

(51) Int. Cl. C25D 11/00; C25D 11/24; C25D 17/10; G21K 1/06

(52) U.S. Cl. CPC C25D 11/005; C25D 11/24; G21K 2207/005; G21K 1/06; C25D 17/10

(57) ABSTRACT

The present invention relates to a device for anodized oxidation of an anode element for a curved X-ray grating, the device (10) comprising: an anode element (12); a cathode element (14); an electrolytic medium (16); a conductor element (18); and a carrier element (20); wherein the anode element (12) comprises a first side (11) and a second side (13), wherein the second side (13) faces opposite to the first side (11); wherein the carrier element (20) comprises a curved surface section (21) that extends along a curvature around a center of curvature (30); wherein the carrier element (20) is configured to receive the second side (13) of the anode element (12) for attaching the conductor element (18) to the first side (11) of the anode element (12); wherein the curved surface section (21) is configured to receive the conductor element (18) after detaching the second side (13) of the anode element (12) from the carrier element (20); wherein the electrolytic medium (16) is configured to connect the anode element (12) and the cathode element (14); wherein the cathode element (14) in conjunction with the anode element (12) and the electrolyte medium (16) is configured to generate at least one group of electric field lines (26) that define a plane (31, 33, 35, 37, 39), wherein at least a straight extrapolation (32) of the group of electric field lines intersect the center of curvature, wherein the generation of the at least one group of electric field lines (26) results in an anodized oxidation of the anode element (12) on the curved surface section (21). The invention provides a device (10) that avoids the risk of damaging the grating structures and getting a low yield.

### FIELD OF THE INVENTION

The present invention relates to a device and a method for anodized oxidation of an anode element for a curved X-ray grating, a system for producing a curved X-ray grating and a curved X-ray grating.

### BACKGROUND OF THE INVENTION

Special grating components are required for dark field X-ray imaging or phase contrast imaging with trench or wall structures that have a width of a few μm and a depth of about 200-300 μm. The trenches are filled with X-ray absorbing material while the walls are transparent or low absorbing for X-ray radiation. In a dark field X-ray imaging system, a so called G2 grating is mounted in front of the detector with a distance between the source and the image of more than 2 m. The G2 grating is used to analyze a wave front of X-ray radiation which travels from an X-ray radiation source through further gratings and an object. This requires a focusing of the grating surface of the G2 grating in direction of the position of the X-ray radiation source.

From US 2007/0183583 A1 it is known to bend an X-ray grating by an external force such that the grating structured on the grating surface are focused on the position of the X-ray radiation source. The bending of the X-ray grating may risk damaging the grating structures and getting a low yield due to a brittleness of a base material of the wall structures of the X-ray grating in combination with a filling material of the trenches.

### SUMMARY OF THE INVENTION

There may thus be a need to provide a device and a method which avoids the risk of damaging the grating structures and getting a low yield.

The object of the present invention is solved by the subject-matter of the independent claims; further embodiments are incorporated in the dependent claims. It should be noted that the following described aspects of the invention apply also for the system, the method, the curved X-ray grating, the computer program element, and the computer readable medium.

According to the present invention, a device for anodized oxidation of an anode element for a curved X-ray grating, the device comprising: an anode element; a cathode element; an electrolytic medium; a conductor element; and a carrier element; wherein the anode element comprises a first side and a second side, wherein the second side faces opposite to the first side; wherein the carrier element comprises a curved surface section that extends along a curvature around a center of curvature; wherein the carrier element is configured to receive the second side of the anode element for attaching the conductor element to the first side of the anode element; wherein the curved surface section is configured to receive the conductor element after detaching the second side of the anode element from the carrier element; wherein the electrolytic medium is configured to connect the anode element and the cathode element; wherein the cathode element in conjunction with the anode element and the electrolyte medium is configured to generate at least one group of electric field lines that define a plane, wherein at least a straight extrapolation of the group of electric field lines intersect the center of curvature, wherein the generation of the at least one group of electric field lines results in an anodized oxidation of the anode element on the curved surface section.

In an aspect of the invention a method is provided for anodized oxidation of an anode element for a curved X-ray grating, wherein the method comprises the steps of attaching an anode element to a carrier element, wherein the anode element comprises a first side and a second side, wherein the second side faces opposite the first side and wherein the carrier element receives the second side, and wherein the carrier element comprises a curved surface section that extends along a curvature around a center of curvature; attaching a conductor element to the first side of the anode element; detaching the anode element from the carrier element; attaching the conductor element being attached to the first side of the anode element to the carrier element; introducing the carrier element with the anode element and a cathode element in an electrolytic medium such that at least one group of electric field lines are generated between the cathode element and the anode element that define a plane wherein at least a straight extrapolation of the group of electric field lines intersect the center of curvature of the curved surface section.

The invention provides a device which may produce a base material of the X-ray grating which is focused to a focal point, before the wall structures and the trenches are created. This so-called “focus first” production uses the anode element as material for the wall structures and the trenches of an X-ray grating to be produced. At first, the first side of the anode element is attached to the carrier element. Then, a conductor element being an electrical conductor element is attached to the second side of the anode element. Afterwards, the conductor element that is attached to the anode element may be attached to a curved surface portion of the carrier element such that the anode element assumes the curved shape of the curved surface portion. The carrier element that carries the conductor element and the anode element is introduced into an electrolytic medium. In conjunction with a cathode element which is also located in the electrolytic medium, the device generates an electric field between the cathode element and the conductor element, wherein the anode element is arranged between the cathode element and the conductor element. Thus, electric field lines starting at the cathode element extend through the anode element and terminate at the conductor element. At least one group of the electric field lines defines a plane, wherein an extrapolation of those electric field lines of that group intersects a center of curvature of the curved surface section.

For dark field X-ray imaging or phase contrast imaging it is important to align X-ray gratings with each other as accurately as possible. How accurately the gratings can be aligned to each other strongly depends on the homogeneity of the period of the grating over the grating area and the shape of the grating, since deviations from an ideal shape of the grating make it impossible to accurately align the gratings for the entire grating area. If the gratings are mechanically bent to account for a cone beam of an X-ray imaging device, this is typically achieved by applying a force to the edges of the grating. This induces a tension to the whole grating area. Especially for large area gratings as needed for conventional radiography (e.g. 43 cm×43 cm) it is not possible to induce a perfect predetermined grating shape with this approach. This deviation from the predetermined ideal grating shape makes an accurate alignment of the gratings not possible, which results in a lower signal-to-noise ratio in the resulting images.

In the present invention the generation of electric field lines which extend through the anode element leads to an anodization of the anode element. The anodization of the anode element leads to an oxidation of the material of the anode element. Due to the oxidization of the material of the anode element, pores are generated in the anode element which extend along the electric field lines. Since the electric field lines point to the intersection point, the pores in the anode element are also directed to that intersection point. Moreover, since the anode element is arranged on the curved surface section, the inherent shape of the anode element is a curved shape and the pores are embedded in that curved shape of the anode element. The anode element which is produced by the device is therefore anodized in a focused shape. Since the anode element already is in the focused shape during the anodization, the anode element may be used as a base material for an X-ray grating having a curved shape. That X-ray grating does not have to be bent after the production since the base material is pre-focused and pre-shaped. Accordingly, the resulting curved X-ray grating is tension-free and thus will hold a predetermined shape without the application of external forces. Therefore, a very accurate alignment of the X-ray gratings as necessary for dark field X-ray imaging or phase contrast imaging can be achieved leading to a high signal-to-noise ratio in the resulting images. Thus, the resulting tension-free curved X-ray grating allows for improving X-ray interferometric imaging.

In an example, the curved surface section of the carrier element may be configured to receive the second side of the anode element.

In an example, the conductor element may be used as a sacrificial anodization conductor for the anodization, that is used to ensure a complete anodization over the full extension of the electric field lines through the anode element.

In a further example, the curvature may have a constant distance to the center of curvature.

In an example, the device is an electrolytic cell comprising a DC voltage generator. In another example, the electrolytic cell may comprise an AC voltage generator.

In an example, the electrolytic medium is liquid.

In an example, the cathode element in conjunction with the anode element and the electrolyte medium generate several groups of electric field lines that define a plurality of parallel planes, wherein at least an extrapolation of each group of electric field lines intersects a focal line that intersects all planes.

According to an example, the anode element comprises an aluminium foil element. The use of aluminium foil as anode element in the anodization results in an anodized aluminium oxidation.

According to an example, the curved surface section of the carrier element has a concave curvature and the cathode element is arranged between the center of curvature and the anode element.

According to another example, the curved surface section of the carrier element has a convex curvature and the anode element is arranged between the center of curvature and the cathode element.

In an example, the further carrier element comprises a flat surface section which is arranged opposite to the curved surface section and which faces in an opposite direction to the curved surface section.

According to an example, the cathode element is a curved area electrode and the curved area electrode extends along a curvature around said center of curvature.

In another example, the cathode element may be a line or point electrode that is arranged in the center of curvature.

According to an example, the cathode element comprises a structured surface for providing a patterned and/or tiled electric field.

In an example, the distance between the center of curvature and the cathode element is in the range between 0.5 m and 4 m, preferably between 1 m and 3.5 m, more preferably between 1.5 m and 3 m, most preferably between 2 m and 2.5 m.

According to the present invention, also a system for producing a curved X-ray grating is provided, the system comprising: a device for curved direct lithography; and a device for anodized oxidation of an anode element according to the above description; wherein the device for curved direct lithography is configured to provide a pattern mask at the first side.

In an example, the system further comprises a sputter device, wherein the sputter device is configured to provide an etch mask on the first side of the anode element.

In a further example, the system further comprises an etching device for removing material from the anode element, wherein the etching device is configured to remove material from those portions of the etch mask and the anode element which are uncovered by the pattern mask resulting in a curved X-ray grating.

The removal of the material from the anode element generates trenches in the anode element. The material of the anode element which is protected by the pattern mask provides wall elements in the anode element. The trenches and the wall elements form a grating structure on the anode element.

The etching device will remove material along the pores which have been generated during the anodization of the anode element. This means, the trenches to the wall elements extend along the direction of the pores in the anodized anode element. Consequently, the trenches and the wall elements point to the same intersection point as the pores, i.e. to the center of curvature of the shape of the anode element. This results in a curved X-ray grating which has a tension-free grating surface, since bending for providing the curved shape of the X-ray grating after the production of the X-ray grating is prevented.

In an example, the curved X-ray grating may be a component of a phase contrast X-ray imaging device, e.g. a dark field X-ray imaging device. In a further example, the curved X-ray grating may be a G2 grating.

In another example, the curved X-ray grating may be rolled and be provided in a rolled configuration for a rolled battery geometry.

In a further example, the carrier elements may have a complex structure that comprises several curved and flat sections.

In an example, if the second side of the anode element covers the curved surface section of the further carrier element, the pattern mask has a curvature which corresponds to the curved surface of the further carrier element.

According to an example, the system comprises a further carrier element which comprises a curved surface section which is complementary to the curved surface section of the carrier element; and wherein the curved surface section of the further carrier element is configured to receive the second side of the oxidized anode element after detaching the conductor element from the carrier element and removing the conductor element from the anode element.

By the attachment of the oxidized anode element to the further carrier element, a further processing of the first side of the oxidized anode element may be performed.

According to an example, the device for curved direct lithography is further configured to provide a pattern mask on a plane first or second side of the anode element, wherein the pattern mask provides a grating pattern with a variable pitch.

According to the present invention, also a method for anodized oxidation of an anode element is provided which uses a device according to the above description or a system for producing a curved X-ray grating according to the above description, the method comprising the following steps: a) covering at least a portion of a carrier element with an anode element having a first side and a second side, wherein the second side connects to the carrier element; b) attaching a conductor element to the first side of the anode element; c) detaching the anode element from the carrier element; d) covering at least a portion of the curved surface section of the carrier element, wherein the conductor element is attached to the first side of the anode element; e) adjusting the carrier element with the anode element and a cathode element in an electrolytic medium such that at least a group of electric field lines which are generated between the cathode element and the anode element defines at least one plane and at least an extrapolation of those field lines intersects a center of curvature of the curved surface section; and f) providing a current between the cathode element and the anode element through the electrolytic medium to perform an anodized oxidation on the anode element on the curved surface section.

In an example, in step f), pores are generated in the anode element, wherein the pores are aligned along the electric field lines.

In an example, the current may be a DC or AC current or a mixture thereof.

According to an example, the method comprises the further steps: g) detaching the conductor element from the carrier element; h) removing the conductor element from the oxidized anode element; and i) covering at least a portion of a curved surface section of a further carrier element with the second side of the anode element, wherein the curved surface section of the further carrier element is complementary to the curved surface section of the carrier element.

According to an example, the method comprises the further steps: j) providing an etch mask on the first side of the anode element using a sputter device and a pattern mask on the etch mask, wherein the pattern mask has a curvature that corresponds to the curved surface of the further carrier element with a device for curved direct lithography; and k) removing material from the anode element which is uncovered by the pattern mask with an etching device, the removal resulting in a curved X-ray grating.

According to the present invention, also a curved X-ray grating is provided that is produced according to the method of the above description, the curved X-ray grating comprising: a curved grating surface; wherein the curved grating surface defines a focal point or a focal line; and wherein the curved grating surface is tension-free. Tension-free means that no external forces are necessary to provide the curved shape of the X-ray grating, i.e. the curved grating surface is free of external bending stress. Thus, a grating is “tension-free” if no force is necessary to hold the grating in its original curved shape such that the grating remains in its original curved shape over time. In contrast thereto a grating is not tension-free, for instance, if the bending of the grating is achieved through applying a mechanical force to the edges of the grating. In such cases, if the external forces are removed, the tension in the grating results in deviations of the grating from its originally curved shape with time as the material relaxes. The tension in the grating can in this case be regarded as being proportional to the deviation of the grating from its originally curved shape once the grating is released from the external mechanical force bringing it into the shape. However, in some examples, the grating surface may comprise internal tension due to a filling process of the grating structures or due to further process steps.

According to the present invention, also a computer program element is provided for controlling a device according to the above description or system according to the above description, which, when being executed by a processing unit, is adapted to perform the method steps according to the above description.

According to the present invention, also a computer readable medium is provided having stored the program element according to the above description.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 shows a schematic drawing of a device for anodized oxidation of an anode element;

FIG. 2a, b show schematic drawings of the device with carrier element having a convex (a) and concave (b) curved surface section;

FIG. 3 shows a sectional side view of an embodiment of the device;

FIG. 4 shows a schematic drawing of the sputter device;

FIG. 5a, b show schematic drawings of a device for curved direct lithography providing a curved (a) grating pattern and a grating pattern with a variable pitch (b);

FIG. 6 shows a schematic drawing of an etching device;

FIG. 7 shows a curved X-ray grating having a tension-free curved grating surface;

FIG. 8a-j show process steps of the method;

FIG. 9 shows a schematic flow chart of the method; and

FIG. 10 shows schematically and exemplarily a part of a grating that deviates from an ideal shape.

### DETAILED DESCRIPTION OF EMBODIMENTS

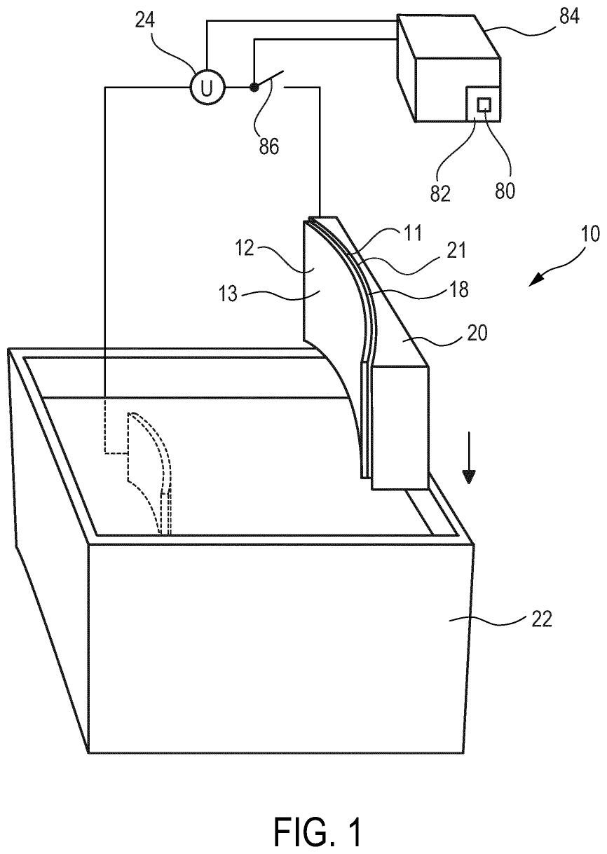

FIG. 1 shows a device 10 for anodized oxidation of an anode element. The device 10 comprises an anode element 12, a cathode element 14, an electrolytic medium 16, a conductor element 18, and a carrier element 20.

The anode element 12 comprises a first side 11 and the second side 13. The second side 13 faces opposite to the first side 11. The anode element 12 may be an aluminium foil. The first side 11 of the aluminium foil may be polished and the second side 13 may be rough.

In FIG. 1, the anode element 12 is attached to the conductor element 18. The conductor element 18 is attached to the carrier element 20. The conductor element 18 is further electrically attached to a voltage source 24.

The cathode element 14 may be a curved area electrode. The cathode element 14 is also attached to the voltage source 24.

The carrier element 20 in conjunction with the conductor element 18 and the anode element 12 may be introduced into the electrolytic medium 16 as denoted by the arrow in FIG. 1. The electrolytic medium 16 may be arranged in a basin 22. The electrolytic medium 16 electrically connects the introduced anode element 12 to the introduced cathode element 14.

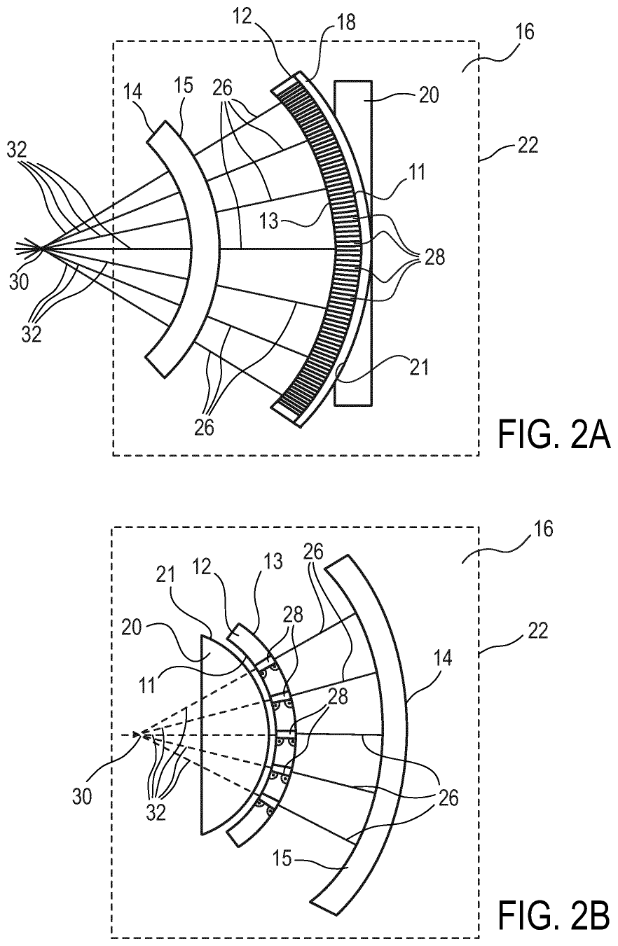

With reference to FIG. 2a, the cathode element 14 and the carrier element 20, the conductor element 18 and the anode element 12 are arranged in the electrolytic medium 16.

The anode element 12 and the conductor element 18 are further arranged on the curved surface section 21 of the carrier element 20. The electric connection of the anode element 12 and the cathode element 14 to the voltage source 24 generates electric field lines 26 which extend between the cathode element 14 and the anode element 12. The electric field lines 26 are arranged in a plane. Extrapolations 32 of the electric field lines 26 intersect in a focal point 30.

The cathode element 14 is arranged between the focal point 30 and the carrier element 20. The cathode element 14 is a curved area electrode which may comprise a structured surface 15, wherein the structured surface 15 may be convex. The structured surface 15 faces the second surface 13 of the anode element 12. The structuring of the structured surface 15 provides a structured pattern of electric field lines which extend through the anode element 12. The structured pattern of electric field lines 26 may improve the patterning of the pores and/or may prepare the anode element 12 for tiling features. In the embodiment of FIG. 2a, the second surface 13 of the anode element 12 is concave.

The focal point 30 is the center of curvature of the curvature of the curved area electrode of the cathode element 14. Furthermore, the focal point 30 is the center of curvature of the curved surface section 21. Since the anode element 12 is connected to the curved surface section 21 by the conductor element 18, the anode element 12 also comprises a curvature having the center of curvature at the focal point 30.

The generation of the electric field lines 26 leads to a current in the electrolytic medium 16 between the cathode element 14 and the anode element 12. Due to this current, an oxidation of the anode element 12 occurs, i.e. the anode element 12 is anodized.

The anodization leads to the formation of pores 28 in the anode element 12. The pores 28 extend along the electric field lines 26. Since the anode element 12 has a curvature which has the center of curvature in the focal point 30, the pores 28 extend perpendicular to the second side 13 and the first side 11 of the anode element 12.

With reference to FIG. 2b, another embodiment of the device 10 is shown. In this embodiment, the curved surface section 21 of the carrier element 20 is convex, wherein the cathode element 14 faces the anode element 12 with a concave surface 15′. This means, that the second side 13 is convex. Furthermore, the carrier element 20 is arranged in between the focal point 30 and the cathode element 14. Also in this embodiment, the pores 28 are arranged perpendicular to the second side 13, since the second side 13 has a curvature with the center of curvature in the focal point 30.

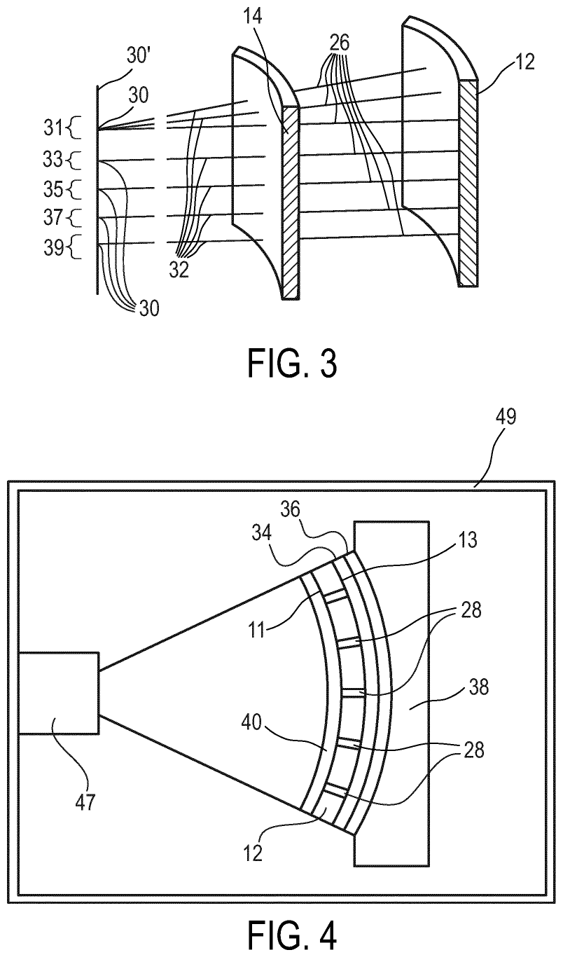

FIG. 3 shows a cross-sectional side view of FIG. 2a along one of the electric field lines 26 which are depicted in FIG. 2a. In this view, several planes 31, 33, 35, 37, 39 are shown, wherein each plane 31, 33, 35, 37, 39 comprises a group of electric field lines 26 which intersect with each other in a focal point 30. For overview reasons, in FIG. 3, only the uppermost plane 31 comprises a group of electric field lines 26. The remaining planes 31, 33, 35, 37, 39 are depicted with just one electric field line 26. This does not exclude that those planes 31, 33, 35, 37, 39 comprise groups of electric field lines 26. The focal point 30 of the uppermost plane 31, 33, 35, 37, 39 is arranged on a focal line 30′. Furthermore, the focal points 30 of the further planes 31, 33, 35, 37, 39 are also arranged on the focal line 30′.

In a further embodiment (not shown) the focal points 30 of the planes 31, 33, 35, 37, 39 are arranged on a single intersection point. In this embodiment, the curvature of the curved surface section 21 and the curvature of the cathode element 14 is two-dimensional, i.e. the curved surface section 21 may for example be a spherical segment.

In both embodiments, pores 28 will be generated along the electric field lines of the planes 31, 33, 35, 37, 39 during the anodization of the anode element 12.

After the anodization, the anode element 12 and the conductor element 18 are removed from the carrier element 20. Then, the conductor element 18 may be removed from the anode element 12. In this example, the conductor element 18 may be a sacrificial anodization conductor (SAC).

The device 10 may be a component of a system for producing a curved X-ray grating. The system for producing a curved X-ray grating further comprises a sputtering device 47, a device 46 for curved direct lithography and an etching device 50 for removing material from the anode element 12. Furthermore, the system may comprise a further carrier element 38 which comprises a further curved surface section 23 which is complementary to the curved surface section 21 of the carrier element 20.

The anodized anode element 12 which comprises the pores 28 may be attached to a plating base 34 and a plating 36. The plating 36 is used for a conductive seed layer which is used for electroplating filling material in trenches of a grating structure after a grating structure has been generated in the anodized anode element 12. FIG. 4 shows the anodized anode element 12 that is attached to the plating base 34 and the plating 36. The plating 36 may further be attached to the further curved surface section 23 of the further carrier element 38. This attachment may be performed by lamination. In this embodiment, the further curved surface section 23 is concave.

The further carrier element 38 may be arranged in a vacuum chamber 49 of the sputtering device 47. In the vacuum chamber, an etch mask 40 may be sputtered on the first side 11 of the anode element 12 by the sputter device 47. After the etch mask 40 has been generated on the anode element 12, the further carrier element 38 is removed from the vacuum chamber 49.

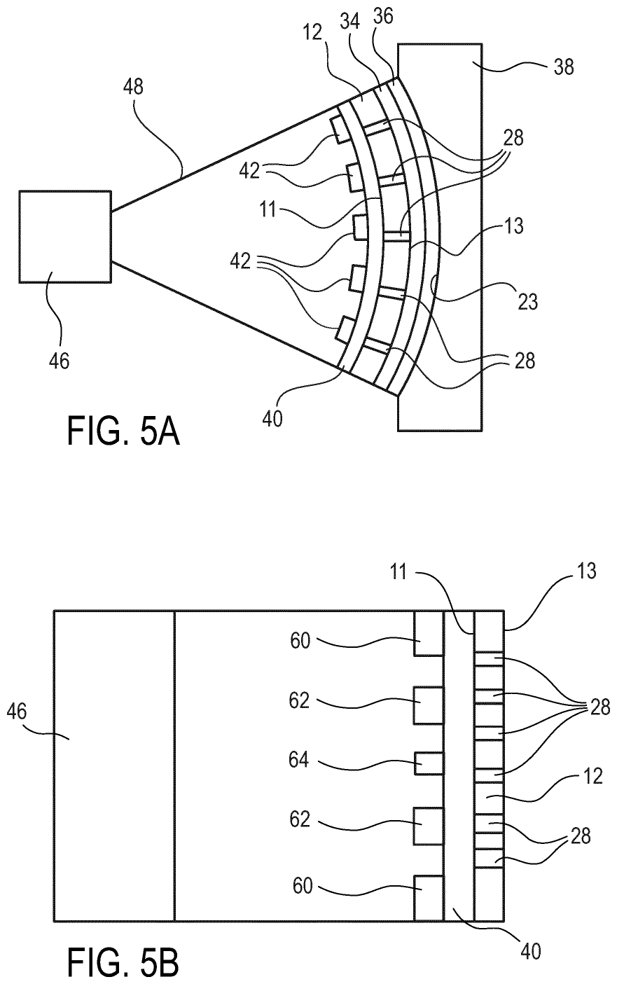

As shown in FIG. 5a, the device 46 for curved direct lithography may then provide a pattern mask 42 on the etch mask 40 by photolithography. The pattern mask 42 comprises portions which cover the etch mask 40 and further portions which do not cover the etch mask 40. The pattern mask 42 may be a mask for a grating.

FIG. 5b shows another embodiment of the device 46 for curved direct lithography. In this embodiment, the device 46 for curved direct lithography provides a pattern mask 42 which has components 60, 62, 64. Those components 60, 62, 64 define a mask for a grating which has a variable pitch.

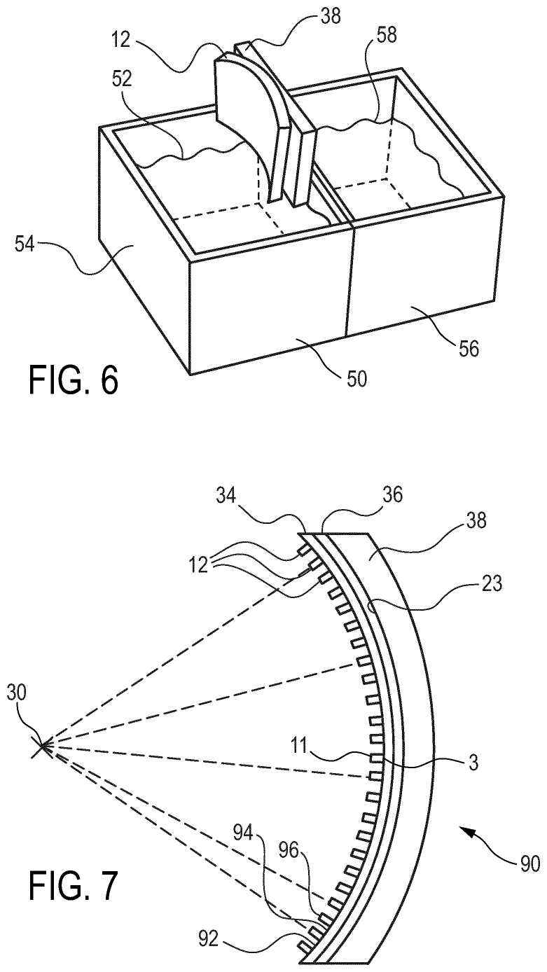

In both embodiments, after the provision of the pattern mask 42, the further carrier element 38 with the anodized anode element 12 is arranged in an etching device 50 according to FIG. 6. The etching device 50 may comprise a first basin 54 and a second basin 56. The first basin 54 may comprise the first etching medium 52. The first etching medium 52 etches the etch mask 40 which is not covered by the pattern mask 42, when the further carrier element 38 is arranged in the etching medium 52. In an exemplary embodiment, the first etching medium 52 may comprise polyethersulphone. However, in further embodiments, the first etching medium 52 may comprise alternative or further components.

The second basin 56 comprises a second etching medium 58 which etches the anodized anode element 12 along the pores 28 at the locations where the etching mask 40 has been removed by the first etching medium 52. In an exemplary embodiment, the second etching medium 58 may for example be H3PO4. However, in further embodiments, the second etching medium 58 may comprise alternative or further components.

As shown in FIG. 7, the etching of the anodized anode element 12 along the pores 28 results in the formation of trenches 94 which extend through the anode element 12 along the direction of the pores 28. The trenches 94 are delimited by wall elements 96. The trenches 94 and the wall elements 96 form a curved grating surface 92 of a curved X-ray grating 90. The wall elements 96 and the trenches 94 point through the first side 11 to the focal point 30. The angle between the first side 11 and the wall elements 96 and the trenches 94, respectively, may be a 90° angle. Furthermore, the curved grating surface 92 is tension-free since the plating 36, the plating base 34, and the wall elements 96 have been produced in the focused alignment.

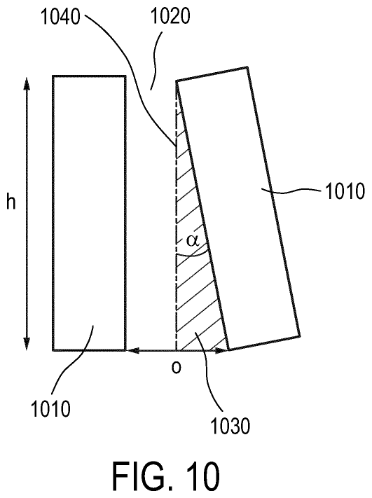

A tension-free grating requires no external force to stay in its originally curved shape comprising a predetermined bending radius. Thus, a tension in the grating can be defined based on a deviation from the predetermined or original shape of the grating if no external force is applied. The deviation can be measured, for instance, by measuring the predetermined and/or original bending radius of a grating and then measuring the bending radius of the grating after some time after the grating has been released from external forces. Moreover, a tension in the grating in the context of this invention can be considered as negligible, i.e. the grating is considered as tension-free, if the deviation of the shape, for instance, of the bending radius, leads to a negligible shadowing of the grating towards the edges of the grating. In particular, the deviation is considered negligible if the deviation of the radius from the predefined or original, i.e. ideal, shape fulfills the equation h*sin(α)≤2.5%*O at the edges of the grating, wherein h is a height of respective absorbing structures, i.e. wall elements, O is a width of an opening, i.e. trench, of the grating, and angle α is the shadow angle defining the shadow area that results from illumination of the grating with non-perfect shape. To illustrate this equation FIG. 10 shows schematically and exemplarily a part of a grating that deviates from an ideal shape. FIG. 10 shows absorbing structures 1010 of a grating that are divided by openings 1020. Further, FIG. 10 shows the height h of the absorbing structures 1010 and the width O of the opening 1020. The width O of the opening 1020 in FIG. 10 is exemplarily measured at the bottom of the absorbing structures 1010. But, since the angle between two adjacent absorbing structures 1010 in reality is very small, the approximation of the above equation also holds, when the width O of the opening 1020 is measured at any other height of the absorbing structures 1010, for instance, at the top or in the middle of the absorbing structures 1010. Due to deviations in the shape of the exemplarily shown grating in FIG. 10, the absorbing structures 1010 are not always parallel to the respective X-rays falling on the grating. Therefore, a shadow area 1030 is formed between two absorbing structures 1010 that cannot be reached by X-rays under the current illumination. The angle α is defined between a last X-ray 1040 reaching through the grating before the shadow area 1030 of an absorbing structure 1010 and the respective edge of the absorbing structure 1010 causing the shadow area 1030.

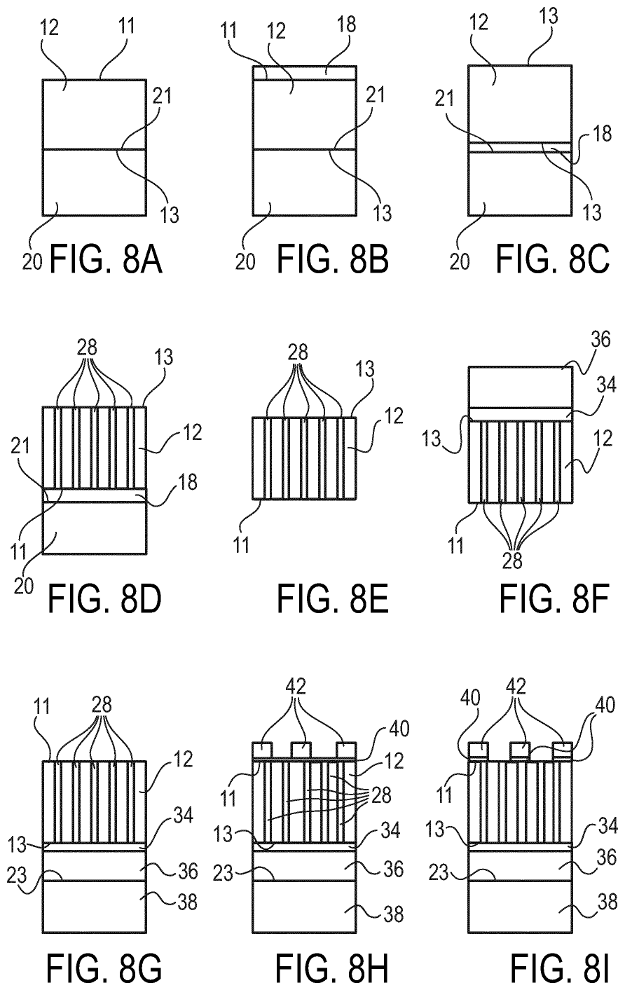

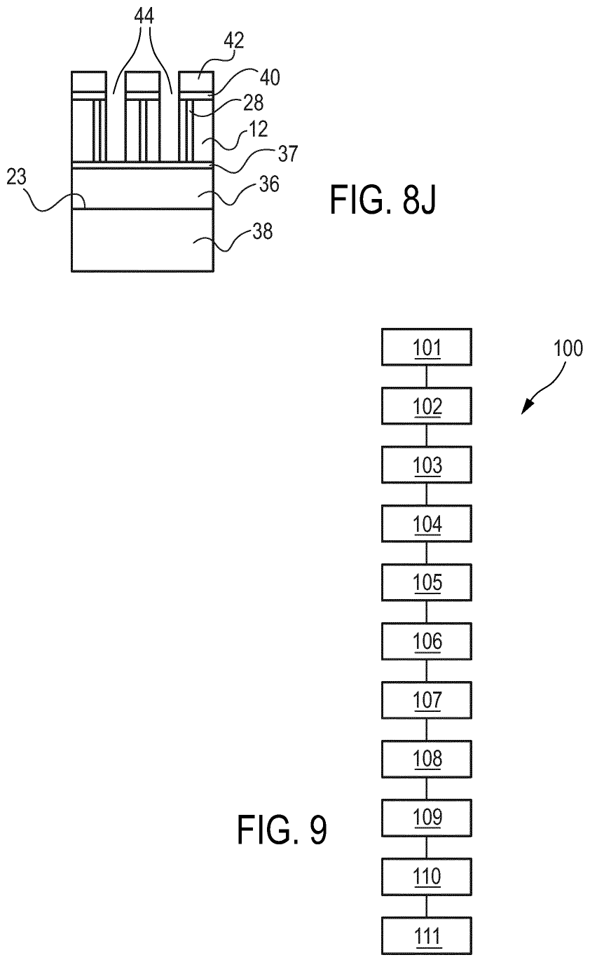

FIG. 8 shows a schematic view of the process steps and FIG. 9 shows a schematic flow chart of a method 100 for anodized oxidation of an anode element is shown. The method 100 uses a device 10 for anodized oxidation of an anode element 12. The device 10 comprises an anode element 12, a cathode element 14, an electrolytic medium 16, a conductor element 18, and a carrier element 20.

The anode element 12 comprises a first side 11 and the second side 13. The second side 13 faces opposite to the first side 11. The anode element 12 may be an aluminium foil. The first side 11 of the aluminium foil may be polished and the second side 13 may be rough.

The anode element 12 may be attached to the carrier element 20 with the second side 13 such that it covers 101 at least a portion of the carrier element according to step a). This is also shown in FIG. 8a. The attachment may be performed by laminating the anode element 12 to the carrier element 20. The conductor element 18 may then be attached 102 to the first side 11 of the anode element 12 according to step b) which is shown in FIG. 8b.

Then, the anode element 12 is turned around, i.e. it is detached 103 from the carrier element 20 according to step c). Then the second side 13 is attached to a curved surface section 21 of the carrier element 20 such that it covers 104 at least a portion of the curved surface section 21 (see FIG. 8c). The curved surface section 21 extends along a curvature around a center of curvature 30. The carrier element 20 may be a glass carrier.

In FIG. 1, the anode element 12 is attached to the conductor element 18. The conductor element 18 is attached to the carrier element 20. The conductor element 18 is further electrically attached to a voltage source 24.

The cathode element 14 may be a curved area electrode. The cathode element 14 is also attached to the voltage source 24.

The carrier element 20 in conjunction with the conductor element 18 and the anode element 12 may be introduced into the electrolytic medium 16 as denoted by the arrow in FIG. 1. The electrolytic medium 16 may be arranged in a basin 22. The electrolytic medium 16 electrically connects the introduced anode element 12 to the introduced cathode element 14.

With reference to FIG. 2a, the cathode element 14 and the carrier element 20, the conductor element 18 and the anode element 12 are arranged in the electrolytic medium 16.

The anode element 12 and the conductor element 18 are further arranged on the curved surface section 21 of the carrier element 20. The electric connection of the anode element 12 and the cathode element 14 to the voltage source 24 generates electric field lines 26 which extend between the cathode element 14 and the anode element 12. The electric field lines 26 are arranged in a plane. Extrapolations 32 of the electric field lines 26 intersect in a focal point 30, i.e. the cathode element 14 and the carrier element 20 that supports the anode element 12 are adjusted 105 in the electrolytic medium 16 according to step e).

The cathode element 14 is arranged between the focal point 30 and the carrier element 20. The cathode element 14 is a curved area electrode which may comprise a structured surface 15, wherein the structured surface 15 may be convex. The structured surface 15 faces the second surface 13 of the anode element 12. The structuring of the structured surface 15 provides a structured pattern of electric field lines which extend through the anode element 12. The structured pattern of electric field lines 26 may improve the patterning of the pores and/or may prepare the anode element 12 for tiling features. In the embodiment of FIG. 2a, the second surface 13 of the anode element 12 is concave.

The focal point 30 is the center of curvature of the curvature of the curved area electrode of the cathode element 14. Furthermore, the focal point 30 is the center of curvature of the curved surface section 21. Since the anode element 12 is connected to the curved surface section 21 by the conductor element 18, the anode element 12 also comprises a curvature having the center of curvature at the focal point 30.

The generation of the electric field lines 26 leads to a current in the electrolytic medium 16 between the cathode element 14 and the anode element 12 according to step f). Due to this current, an oxidation of the anode element 12 occurs, i.e. the anode element 12 is anodized.

The anodization leads to the formation of pores 28 in the anode element 12 being shown in FIG. 8d. The pores 28 extend along the electric field lines 26. Since the anode element 12 has a curvature which has the center of curvature in the focal point 30, the pores 28 extend perpendicular to the second side 13 and the first side 11 of the anode element 12.

With reference to FIG. 2b, another embodiment of the device 10 is shown. In this embodiment, the curved surface section 21 of the carrier element 20 is convex, wherein the cathode element 14 faces the anode element 12 with a concave surface 15′. This means, that the second side 13 is convex. Furthermore, the carrier element 20 is arranged in between the focal point 30 and the cathode element 14. Also in this embodiment, the pores 28 are arranged perpendicular to the second side 13, since the second side 13 has a curvature with the center of curvature in the focal point 30.

FIG. 3 shows a cross-sectional side view of FIG. 2a along one of the electric field lines 26 which are depicted in FIG. 2a. In this view, several planes 31, 33, 35, 37, 39 are shown, wherein each plane 31, 33, 35, 37, 39 comprises a group of electric field lines 26 which intersect with each other in a focal point 30. For overview reasons, in FIG. 3, only the uppermost plane 31 comprises a group of electric field lines 26. The remaining planes 31, 33, 35, 37, 39 are depicted with just one electric field line 26. This does not exclude that those planes 31, 33, 35, 37, 39 comprise groups of electric field lines 26. The focal point 30 of the uppermost plane 31, 33, 35, 37, 39 is arranged on a focal line 30′. Furthermore, the focal points 30 of the further planes 31, 33, 35, 37, 39 are also arranged on the focal line 30′.

In a further embodiment (not shown) the focal points 30 of the planes 31, 33, 35, 37, 39 are arranged on a single intersection point. In this embodiment, the curvature of the curved surface section 21 and the curvature of the cathode element 14 is two-dimensional, i.e. the curved surface section 21 may for example be a spherical segment. In both embodiments, pores 28 will be generated along the electric field lines of the planes 31, 33, 35, 37, 39 during the anodization of the anode element 12.

After the anodization, the anode element 12 and the conductor element 18 are detached 107 from the carrier element 20 according to step g). The conductor element 18 may be removed 108 from the anode element 12 according to step h). In this example, the conductor element 18 may be a sacrificial anodization conductor (SAC). The anodized anode element 12 that has the conductor element 18 removed is shown in FIG. 8e.

The device 10 may be a component of a system for producing a curved X-ray grating. The system for producing a curved X-ray grating further comprises a sputtering device 47, a device 46 for curved direct lithography and an etching device 50 for removing material from the anode element 12. Furthermore, the system may comprise a further carrier element 38 which comprises a further curved surface section 23 which is complementary to the curved surface section 21 of the carrier element 20.

The anodized anode element 12 which comprises the pores 28 may be attached to a plating base 34 and a plating 36. The plating 36 is used for a conductive seed layer which is used for electroplating filling material in trenches of a grating structure after a grating structure has been generated in the anodized anode element 12. FIG. 4 and FIG. 8f show the anodized anode element 12 that is attached to the plating base 34 and the plating 36. The plating 36 may further be attached to the further curved surface section 23 of the further carrier element 38, i.e. at least a portion of the further curved surface section 23 is covered 109 by the second side of the anode element 12. This also shown in FIG. 8g. The attachment may be performed by lamination. In this embodiment, the further curved surface section 23 is concave.

The further carrier element 38 may be arranged in a vacuum chamber 49 of the sputtering device 47. In the vacuum chamber, an etch mask 40 may be sputtered on the first side 11 of the anode element 12 by the sputter device 47. After the etch mask 40 has been generated on the anode element 12, the further carrier element 38 is removed from the vacuum chamber 49.

As shown in FIG. 5a, the device 46 for curved direct lithography may then provide a pattern mask 42 on the etch mask 40 by photolithography. The pattern mask 42 comprises portions which cover the etch mask 40 and further portions which do not cover the etch mask 40. The pattern mask 42 may be a mask for a grating pattern as shown in FIG. 8h.

Thus, an etch mask 40 and a pattern mask 42 have been provided 110 according to step j).

FIG. 5b shows another embodiment of the device 46 for curved direct lithography. In this embodiment, the device 46 for curved direct lithography provides a pattern mask 42 which has components 60, 62, 64. Those components 60, 62, 64 define a mask for a grating which has a variable pitch.

In both embodiments, after the provision of the pattern mask 42, the further carrier element 38 with the anodized anode element 12 is arranged in an etching device 50 according to FIG. 6. The etching device 50 may comprise a first basin 54 and a second basin 56. The first basin 54 may comprise the first etching medium 52. The first etching medium 52 etches the etch mask 40 which is not covered by the pattern mask 42, when the further carrier element 38 is arranged in the etching medium 52. In an exemplary embodiment, the first etching medium 52 may comprise polyethersulphone. However, in further embodiments, the first etching medium 52 may comprise alternative or further components. This is shown in FIG. 8i.

The second basin 56 comprises a second etching medium 58 which etches the anodized anode element 12 along the pores 28 at the locations where the etching mask 40 has been removed by the first etching medium 52. In an exemplary embodiment, the second etching medium 58 may for example be H3PO4. However, in further embodiments, the second etching medium 58 may comprise alternative or further components. This means that material from the anode element 12 is removed 111 according to step k) and FIG. 8j. As shown in FIG. 7, the etching of the anodized anode element 12 along the pores 28 results in the formation of trenches 94 which extend through the anode element 12 along the direction of the pores 28. The trenches 94 are delimited by wall elements 96. The trenches 94 and the wall elements 96 form a curved grating surface 92 of a curved X-ray grating 90. The wall elements 96 and the trenches 94 point through the first side 11 to the focal point 30. The angle between the first side 11 and the wall elements 96 and the trenches 94, respectively, may be a 90° angle. Furthermore, the curved grating surface 92 is tension-free since the plating 36, the plating base 34, and the wall elements 96 have been produced in the focused alignment.

In another exemplary embodiment of the present invention, a computer program or a computer program element 80 as shown in FIG. 1 is provided that is characterized by being adapted to execute the method steps of the method according to one of the preceding embodiments, on an appropriate system.

The computer program element 80 might therefore be stored on a computer unit 84 which is shown in FIG. 1, which might also be part of an embodiment of the present invention. This computing unit may be adapted to perform or induce a performing of the steps of the method described above. Moreover, it may be adapted to operate the components of the above described apparatus. The computing unit can be adapted to operate automatically and/or to execute the orders of a user. A computer program may be loaded into a working memory of a data processor. The data processor may thus be equipped to carry out the method of the invention.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above.

Furthermore, the computer program element 80 may be able to switch on an off the voltage source 24 with a switch 86 shown in FIG. 1.

According to a further exemplary embodiment of the present invention, a computer readable medium 82, such as a CD-ROM, is presented wherein the computer readable medium 82 has a computer program element 80 stored on it which computer program element is described by the preceding section. A computer program may be stored and/or distributed on a suitable medium, such as an optical storage medium or a solid-state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated, and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A device for anodized oxidation of an anode element for a curved X-ray grating, the device comprising:
an anode element;
a cathode element;
an electrolytic medium;
a conductor element; and
a carrier element;
wherein the anode element comprises a first side and a second side, wherein the second side faces opposite to the first side;
wherein the carrier element comprises a curved surface section that extends along a curvature around a center of curvature;
wherein the carrier element is configured to receive the second side of the anode element for attaching the conductor element to the first side of the anode element;
wherein the curved surface section is configured to receive the conductor element after detaching the second side of the anode element from the carrier element;
wherein the electrolytic medium is configured to connect the anode element and the cathode element;
wherein the cathode element in conjunction with the anode element and the electrolyte medium is configured to generate at least one group of electric field lines that define a plane, wherein at least a straight extrapolation of the group of electric field lines intersect the center of curvature, wherein the generation of the at least one group of electric field lines results in an anodized oxidation of the anode element on the curved surface section.

2. The device according to claim 1, wherein the anode element comprises an aluminum foil element.

3. The device according to claim 1, wherein the curved surface section of the carrier element has a concave curvature; and wherein the cathode element is arranged between the center of curvature and the anode element.

4. The device according to claim 1, wherein the curved surface section of the carrier element has a convex curvature; and wherein the anode element is arranged between the center of curvature and the cathode element.

5. The device according to claim 1, wherein the cathode element is a curved area electrode; and wherein the curved area electrode extends along a curvature around said center of curvature.

6. The device according to claim 1, wherein the cathode element comprises a structured surface for providing at least one of a patterned and a tiled electric field.

7. A system for producing a curved X-ray grating, the system comprising:
a first device for curved direct lithography; and
a second device for anodized oxidation of an anode element according to claim 1;
wherein the first device for curved direct lithography is configured to provide a pattern mask at the first side.

8. The System according to claim 7, further comprising a further carrier element which comprises a further curved surface section which is complementary to the curved surface section of the carrier element; and
wherein the curved surface section of the further carrier element is configured to receive the second side of the oxidized anode element after detaching the conductor element from the carrier element and removing the conductor element from the anode element.

9. The system according to claim 7, wherein the second device for curved direct lithography is further configured to provide a pattern mask on a plane on a first or second side of the anode element, the pattern mask providing a grating pattern with a variable pitch.

10. A method for anodized oxidation of an anode element for a curved X-ray grating, the method comprising:
covering at least a portion of a carrier element with an anode element that comprises a first side and a second side, wherein the second side connects to the carrier element;
attaching a conductor element to the first side of the anode element;
detaching the anode element from the carrier element;
covering at least a portion of the curved surface section of the carrier element, wherein the conductor element is attached to the first side of the anode element;
adjusting the carrier element with the anode element and a cathode element in an electrolytic medium such that at least a group of electric field lines which are generated between the cathode element and the anode element defines at least one plane and at least an extrapolation of those field lines intersects a center of curvature of the curved surface section; and
providing a current between the cathode element and the anode element through the electrolytic medium to perform an anodized oxidation at the anode element on the curved surface section.

11. The method according to claim 10, further comprising:
detaching the conductor element from the carrier element;
removing the conductor element from the oxidized anode element; and
covering at least a portion of a curved surface section of a further carrier element with the second side of the anode element, wherein the curved surface section of the further carrier element is complementary to the curved surface section of the carrier element.

12. The method according to claim 11, further comprising:
providing an etch mask on the first side of the anode element using a sputter device and a pattern mask on the etch mask, wherein the pattern mask has a curvature that corresponds to the curved surface of the further carrier element with a device for curved direct lithography; and
removing material from the anode element which is uncovered by the pattern mask with an etching device, the removal resulting in a curved X-ray grating.

13-15. (canceled)
